(19) United States
(12) Patent Application Publication
(10) Pub. No.: US 2023/0195288 A1
(43) Pub. Date: Jun. 22, 2023

(54) METHOD AND APPARATUS FOR DETECTING A CLICK ON AN ICON, DEVICE, AND STORAGE MEDIUM

(71) Applicant: Beijing Zitiao Network Technology Co., Ltd., Beijing (CN)

(72) Inventors: Yuan XU, Beijing (CN); Jie YANG, Beijing (CN); Yifeng WANG, Beijing (CN)

(21) Appl. No.: 18/071,394

(22) Filed: Nov. 29, 2022

(30) Foreign Application Priority Data
Dec. 17, 2021 (CN) 202111554937.X

(51) Int. Cl. G06F 3/04842; G06F 7/544; G06T 7/194

(52) U.S. Cl. CPC G06F 3/04842; G06F 7/5443; G06T 7/194

(57) ABSTRACT

Provided are a method and apparatus for detecting a click on an icon, a device, and a storage medium. The method includes: acquiring an original image including a target icon; segmenting the original image into a foreground and a background to obtain a two-dimensional mask image, where a value of a pixel point in the two-dimensional mask image represents whether the pixel point corresponds to the target icon; acquiring position information of a click operation on a control corresponding to the target icon; determining whether the position information and a value of a pixel point corresponding to the position information in the two-dimensional mask image satisfy a set condition; and if so, determining that the target icon is clicked and controlling the target icon to execute a service logic corresponding to the click operation.

This application claims priority to the Chinese patent application No. 202111554937.X filed on Dec. 17, 2021, the content of which is incorporated herein by reference in its entirety.

### TECHNICAL FIELD

Embodiments of the present disclosure relate to the technical field of image processing and, in particular, to a method and apparatus for detecting a click on an icon, a device, and a storage medium.

### BACKGROUND

Existing manners for determining a click on an icon are mostly based on image features. For example, a pixel color feature or a transparency feature of a click position is determined so that whether a click hits an icon region is distinguished. This determination manner has its limitations and cannot be universally applicable to a general interface framework. Moreover, to determine the click, a memory often needs to hold image data and thus is occupied.

### SUMMARY

Embodiments of the present disclosure provide a method and apparatus for detecting a click on an icon, a device, and a storage medium, which can accurately and quickly detect a click on an icon in an interface.

In a first aspect, embodiments of the present disclosure provide a method for detecting a click on an icon. The method includes the steps described below.

An original image including a target icon is acquired.

The original image is segmented into a foreground and a background so that a two-dimensional mask image is obtained, where a value of a pixel point in the two-dimensional mask image represents whether the pixel point corresponds to the target icon.

Position information of a click operation on a control corresponding to the target icon is acquired.

It is determined whether the position information and a value of a pixel point corresponding to the position information in the two-dimensional mask image satisfy a set condition.

If the position information and the value of the pixel point corresponding to the position information in the two-dimensional mask image satisfy the set condition, it is determined that the target icon is clicked and the target icon is controlled to execute a service logic corresponding to the click operation.

In a second aspect, embodiments of the present disclosure further provide an apparatus for detecting a click on an icon. The apparatus includes an original image acquisition module, a foreground and background segmentation module, a position information acquisition module, a determination module, and a click determination module.

The original image acquisition module is configured to acquire an original image including a target icon.

The foreground and background segmentation module is configured to segment the original image into a foreground and a background to obtain a two-dimensional mask image, where a value of a pixel point in the two-dimensional mask image represents whether the pixel point corresponds to the target icon.

The position information acquisition module is configured to acquire position information of a click operation on a control corresponding to the target icon.

The determination module is configured to determine whether the position information and a value of a pixel point corresponding to the position information in the two-dimensional mask image satisfy a set condition.

The click determination module is configured to, if the position information and the value of the pixel point corresponding to the position information in the two-dimensional mask image satisfy the set condition, determine that the target icon is clicked and control the target icon to execute a service logic corresponding to the click operation.

In a third aspect, embodiments of the present disclosure further provide an electronic device. The electronic device includes one or more processing apparatuses and a storage apparatus.

The storage apparatus is configured to store one or more programs.

The one or more programs, when executed by the one or more processing apparatuses, cause the one or more processing apparatuses to perform the method for detecting a click on an icon in the embodiments of the present disclosure.

In a fourth aspect, embodiments of the present disclosure further provide a computer-readable medium, which is configured to store a computer program which, when executed by a processing apparatus, causes the processing apparatus to perform the method for detecting a click on an icon in the embodiments of the present disclosure.

The embodiments of the present disclosure disclose the method and apparatus for detecting a click on an icon, the device, and the storage medium. The original image including the target icon is acquired; the original image is segmented into the foreground and the background so that the two-dimensional mask image is obtained, where the value of the pixel point in the two-dimensional mask image represents whether the pixel point corresponds to the target icon; the position information of the click operation on the control corresponding to the target icon is acquired; it is determined whether the position information and the value of the pixel point corresponding to the position information in the two-dimensional mask image satisfy the set condition; and if the position information and the value of the pixel point corresponding to the position information in the two-dimensional mask image satisfy the set condition, it is determined that the target icon is clicked and the target icon is controlled to execute the service logic corresponding to the click operation. According to the method for detecting a click on an icon in the embodiments of the present disclosure, whether the position information and the value of the pixel point corresponding to the position information in the two-dimensional mask image satisfy the set condition is determined so that whether the icon is clicked is determined, and the click on the icon in the interface can be accurately and quickly detected.

### BRIEF DESCRIPTION OF DRAWINGS

FIG. 1 is a flowchart of a method for detecting a click on an icon according to an embodiment of the present disclosure;

FIG. 2A is an example diagram of an original image corresponding to a target icon according to an embodiment of the present disclosure;

FIG. 2B is a schematic diagram of a bit array corresponding to a target icon according to an embodiment of the present disclosure;

FIG. 3 is a structural diagram of an apparatus for detecting a click on an icon according to an embodiment of the present disclosure; and

FIG. 4 is a structural diagram of an electronic device according to an embodiment of the present disclosure.

### DETAILED DESCRIPTION

Embodiments of the present disclosure are described in more detail hereinafter with reference to the drawings. The drawings illustrate some embodiments of the present disclosure, but it is to be understood that the present disclosure may be implemented in various manners and should not be construed as limited to the embodiments set forth herein. These embodiments are provided for the purpose of understanding the present disclosure thoroughly and completely. It is to be understood that the drawings and embodiments of the present disclosure are illustrative and are not intended to limit the scope of the present disclosure.

It is to be understood that steps described in method embodiments of the present disclosure may be performed in sequence and/or in parallel. Additionally, the method embodiments may include additional steps and/or omit some of the illustrated steps. The scope of the present disclosure is not limited in this respect.

The term “include” and variations thereof used herein refer to “including, but not limited to”. The term “based on” refers to “at least partially based on”. The term “an embodiment” refers to “at least one embodiment”. The term “another embodiment” refers to “at least one another embodiment”. The term “some embodiments” refers to “at least some embodiments”. Definitions of other terms are given in the description hereinafter.

It is to be noted that concepts such as “first” and “second” in the present disclosure are used to distinguish between apparatuses, between modules, or between units and are not intended to limit the order or mutual dependence of the functions performed by these apparatuses, modules, or units.

It is to be noted that “one” and “multiple” mentioned in the present disclosure are not limiting but illustrative. It is to be understood by those skilled in the art that “one” and “multiple” are construed as “one or more” unless otherwise specified in the context.

Names of messages or information exchanged between apparatuses in embodiments of the present disclosure are used for an illustrative purpose and are not to limit the scope of such messages or information.

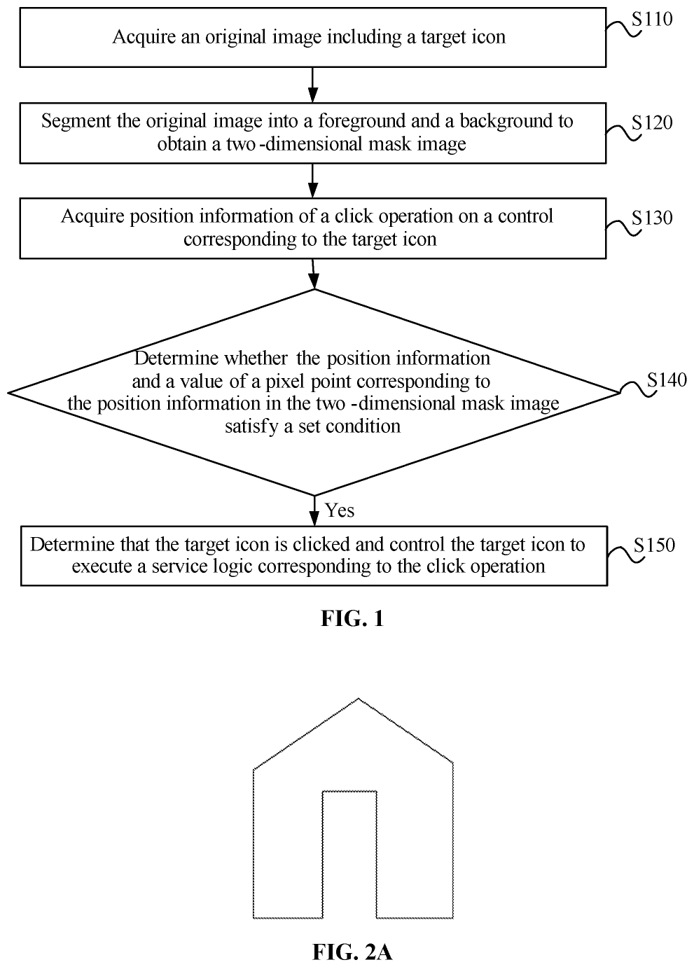

FIG. 1 is a flowchart of a method for detecting a click on an icon according to embodiment one of the present disclosure. The embodiment is applicable to the case where a click on an image is detected. The method may be performed by an apparatus for detecting a click on an icon. The apparatus may be composed of hardware and/or software and generally may be integrated in a device having a function of detecting a click on a webpage rendering icon. The device may be an electronic device such as a server, a mobile terminal, or a server cluster. As shown in FIG. 1, the method includes the steps described below.

In S110, an original image including a target icon is acquired.

The target icon may be an icon composed of a regular pattern or an irregular pattern, and the original image includes the target icon and a background region. The embodiment is applied to a scenario of a display interface, and the target icon may be understood as an icon displayed on an interface. The target icon may be disposed on a button control, and a layout is drawn such that the button control on which the target icon is disposed is displayed at a set position of the display interface.

In S120, the original image is segmented into a foreground and a background so that a two-dimensional mask image is obtained.

A value of a pixel point in the two-dimensional mask image represents whether the pixel point corresponds to the target icon. In the embodiment, a region where the target icon is located is a foreground region and the remaining region is a background region. Label information may be represented by set numerical values including “0”, “1”, “2”, and “3”, where 0 represents the background, 1 represents the foreground, 2 represents a probable background, and 3 represents a probable foreground.

In an embodiment, the original image may be segmented into the foreground and the background by using any existing image segmentation algorithm (for example, a GrabCut algorithm) so that the label information for whether each pixel point in the original image is the target icon is obtained and the two-dimensional mask image is obtained.

In an embodiment, a manner for segmenting the original image into the foreground and the background to obtain the two-dimensional mask image may be performing gradation processing on the original image to obtain a grayscale image and segmenting the grayscale image into the foreground and the background to obtain the two-dimensional mask image.

A process of performing the gradation processing on the original image may be understood as converting a color value of each pixel point in the original image into a grayscale value from 0 to 255 to obtain the grayscale image. After the grayscale image is obtained, the grayscale image is segmented into the foreground and the background by using the GrabCut algorithm so that the two-dimensional mask image which represents whether the pixel points corresponds to a target icon is obtained. In the embodiment, the original image is subjected to the gradation processing and then segmented into the foreground and the background so that image segmentation efficiency can be improved.

In S130, position information of a click operation on a control corresponding to the target icon is acquired.

In the embodiment, the target icon is displayed in the interface window, and a user may trigger the click operation in the interface window through a mouse or a touch pen. An operating system detects the click operation of the user in the interface window, acquires position information of the click operation in the interface window, and then converts the position information in the interface window into the position information on the control where the target icon is located.

In an embodiment, the process of acquiring the position information of the click operation in the region where the target icon is located may be acquiring the position information of the click operation in the interface window; acquiring a transformation matrix between the interface window and the control where the target icon is located; and transforming the position information according to the transformation matrix to obtain the position information of the click operation on the control where the target icon is located.

In an embodiment, the manner for transforming the position information according to the transformation matrix to obtain the position information of the click operation on the control where the target icon is located may be calculating a dot product of the position information and an inverse matrix of the transformation matrix to obtain the position information of the click operation on the control where the target icon is located.

In the embodiment, the system may acquire a click position in the interface window and the click position is set to (p_{gx},p_{gy}). Assuming that the target icon is disposed on a button control named BtnIcon, the layout is drawn so that a position (Btn_{gx}, Btn_{gy}) of BtnIcon in the interface window may be obtained. In this manner, a transformation matrix Trans_{2*2} from positions on the button to positions in the interface window may be obtained, and then a click position on BtnIcon is obtained according to the following formula:

(pₗₓ,p_{ly})=(p_{gx},p_{gy})·Trans_{2*2}⁻.

In the embodiment, the click position on the control is determined by the transformation matrix between the interface window and the control where the target icon is located so that the click position on the control can be accurately acquired, thereby facilitating the subsequent accurate detection of a click on the target icon.

In S140, it is determined whether the position information and a value of a pixel point corresponding to the position information in the two-dimensional mask image satisfy a set condition. If the position information and the value of the pixel point corresponding to the position information in the two-dimensional mask image satisfy the set condition, S150 is performed.

Satisfying the set condition may be understood as whether the value of the pixel point is “1” or “3”. If the value of the pixel point corresponding to the position information of the click operation in the two-dimensional mask image is “1” or “3”, it is determined that the target icon is clicked; otherwise, it is determined that the target icon is not clicked. That is, if the click position of the click operation is the “foreground” or the “probable foreground”, the target icon is clicked.

In S150, it is determined that the target icon is clicked and the target icon is controlled to execute a service logic corresponding to the click operation.

The service logic is associated with the click operation in a service layer and is set by a technician. For example, in response to a single-click on the target icon, page A is jumped to, and in response to a double-click on the target icon, page B is jumped to. The service logic is not limited here and self-defined by the user.

In an embodiment, after the original image is segmented into the foreground and the background so that the two-dimensional mask image is obtained, the following step is further included: a bit array is created according to the two-dimensional mask image and dimension information of the original image. A process of determining whether the position information and the value of the pixel point corresponding to the position information in the two-dimensional mask image satisfy the set condition may be determining whether a value of a position corresponding to the position information in the bit array is a first set value.

The dimension information may include a width and a height. The bit array may be understood as a bitset array, that is, each element in the array occupies one bit. The first set value may be set to be “1”. In the embodiment, a value of each bit in the bit array represents whether a corresponding pixel point in the original image belongs to the target icon. If the value of the bit is “1”, it indicates that the pixel point is the target icon. If the value of the bit is “0”, it indicates that the pixel point is not the target icon. In the embodiment, the bit array assists in the detection of the click on the target icon so that image information can be compressed at least eight times, thereby reducing the memory occupied by images, saving system resources, and increasing a click detection speed.

In an embodiment, a process of creating the bit array according to the two-dimensional mask image and the dimension information of the original image may be creating an empty bit array with a corresponding size according to the dimension information of the original image; and traversing pixel points in the two-dimensional mask image; if a value of a traversed pixel point satisfies a first condition, setting a value of a position corresponding to the pixel point in the empty bit array to be the first set value; and if a value of a traversed pixel point satisfies a second condition, setting a value of a position corresponding to the pixel point in the empty bit array to be a second set value.

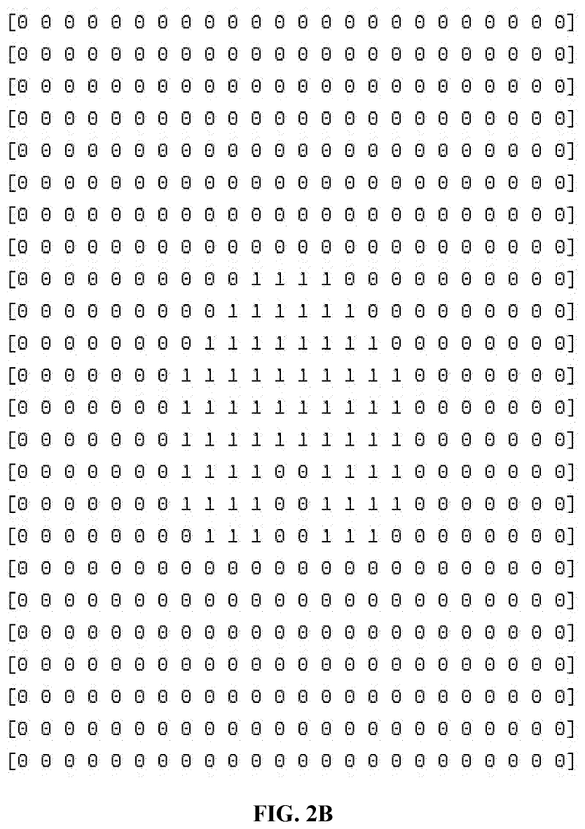

The first condition is that the pixel point is the foreground, and the second condition is that the pixel point is the background. That is, the first condition may be that the label information is “1” or “3”, and the second condition may be that the label information is “0” or “2”. In an embodiment, the bit array with a size of Width * Height is created according to the dimension information of the original image, and then the two-dimensional mask image is traversed. If an array value in an i-th row and a j-th column is 1 or 3, a value of (i*width+j) in the bit array is set to be 1. If the array value in the i-th row and the j-th column is 0 or 2, the value of (i*width+j) in the bit array is set to be 0. That is, foreground and background information of the image is recorded in the bit array in the form of 1 and 0. For example, FIG. 2A is an example diagram of an original image corresponding to a target icon and FIG. 2B is a schematic diagram of a bit array corresponding to a target icon. As shown in FIG. 2B, “1” represents that the pixel point is the target icon, and “0” represents that the pixel point is the background. In the embodiment, values of bits in the bit array are determined by values of the pixel points in the two-dimensional mask image so that the bit array corresponds to the two-dimensional mask image, thereby improving the accuracy of the bit array and the accuracy of click detection.

In an embodiment, after the bit array is created according to the two-dimensional mask image and the dimension information of the original image, the following step is further included: the original image and the dimension information are deleted from a memory.

In the embodiment, after the bit array is obtained, the click on the target icon may be detected according to only the bit array. Therefore, the original image and the dimension information may be deleted from the memory, thereby saving a memory space and increasing the click detection speed.

According to technical schemes in the embodiment of the present disclosure, the original image including the target icon is acquired; the original image is segmented into the foreground and the background so that the two-dimensional mask image is obtained, where the value of the pixel point in the two-dimensional mask image represents whether the pixel point corresponds to the target icon; the position information of the click operation on the control corresponding to the target icon is acquired; it is determined whether the position information and the value of the pixel point corresponding to the position information in the two-dimensional mask image satisfy the set condition; and if the position information and the value of the pixel point corresponding to the position information in the two-dimensional mask image satisfy the set condition, it is determined that the target icon is clicked and the target icon is controlled to execute the service logic corresponding to the click operation. According to the method for detecting a click on an icon in the embodiment of the present disclosure, whether the position information and the value of the pixel point corresponding to the position information of the click in the two-dimensional mask image satisfy the set condition is determined so that whether the icon is clicked is determined, and the click on the icon in the interface can be accurately and quickly detected.

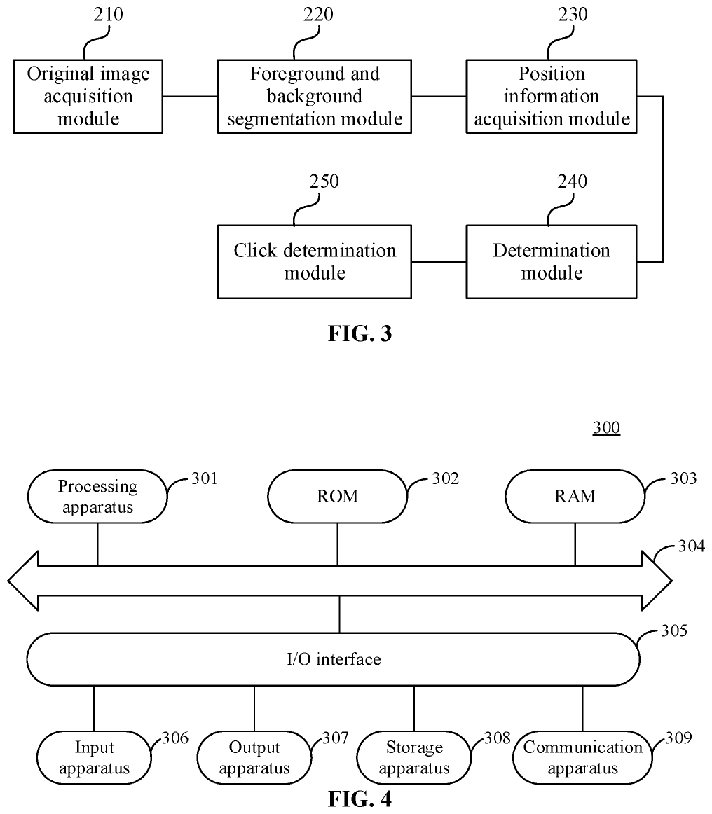

FIG. 3 is a structural diagram of an apparatus for detecting a click on an icon according to an embodiment of the present disclosure. As shown in FIG. 3, the apparatus includes an original image acquisition module 210, a foreground and background segmentation module 220, a position information acquisition module 230, a determination module 240, and a click determination module 250.

The original image acquisition module 210 is configured to acquire an original image including a target icon.

The foreground and background segmentation module 220 is configured to segment the original image into a foreground and a background to obtain a two-dimensional mask image, where a value of a pixel point in the two-dimensional mask image represents whether the pixel point corresponds to the target icon.

The position information acquisition module 230 is configured to acquire position information of a click operation on a control corresponding to the target icon.

The determination module 240 is configured to determine whether the position information and a value of a pixel point corresponding to the position information in the two-dimensional mask image satisfy a set condition.

The click determination module 250 is configured to, in the case where the position information and the value of the pixel point corresponding to the position information in the two-dimensional mask image satisfy the set condition, determine that the target icon is clicked and control the target icon to execute a service logic corresponding to the click operation.

In an embodiment, the foreground and background segmentation module 220 is further configured to perform gradation processing on the original image to obtain a grayscale image and segment the grayscale image into the foreground and the background to obtain the two-dimensional mask image.

In an embodiment, a bit array creation module is further included.

The bit array creation module is configured to create a bit array according to the two-dimensional mask image and dimension information of the original image.

In an embodiment, the determination module 240 is further configured to determine whether a value of a position corresponding to the position information in the bit array is a first set value.

In an embodiment, the bit array creation module is further configured to create an empty bit array with a corresponding size according to the dimension information of the original image; traverse pixel points in the two-dimensional mask image; if a value of a traversed pixel point satisfies a first condition, set a value of a position corresponding to the pixel point in the empty bit array to be the first set value; and if a value of a traverse pixel point satisfies a second condition, set a value of a position corresponding to the pixel point in the empty bit array to be a second set value. The first condition is that the pixel point is the foreground, and the second condition is that the pixel point is the background.

In an embodiment, an image deletion module is further included.

The image deletion module is configured to delete the original image and the dimension information from a memory.

In an embodiment, the position information acquisition module 230 is further configured to acquire position information of the click operation in an interface window; acquire a transformation matrix between the interface window and the control where the target icon is located; and transform the position information according to the transformation matrix to obtain the position information of the click operation on the control where the target icon is located.

In an embodiment, the position information acquisition module 230 is further configured to calculate a dot product of the position information and an inverse matrix of the transformation matrix to obtain the position information of the click operation on the control where the target icon is located.

The preceding apparatus may perform the method provided in all the preceding embodiments of the present disclosure and has function modules and beneficial effects corresponding to the performed method. For technical details that are not described in detail in the embodiment, reference may be made to the method provided in all the preceding embodiments of the present disclosure.

Referring to FIG. 4, FIG. 4 shows a structural diagram of an electronic device 300 suitable for implementing embodiments of the present disclosure. The electronic device in the embodiments of the present disclosure may include, but is not limited to, mobile terminals such as a mobile phone, a laptop, a digital broadcast receiver, a personal digital assistant (PDA), a portable Android device (PAD), a portable media player (PMP), and an in-vehicle terminal (such as an in-vehicle navigation terminal) and stationary terminals such as a digital television (TV) and a desktop computer or various forms of servers such as an independent server or a server cluster. The electronic device shown in FIG. 4 is merely an example and should not impose any limitation to the function and usage scope of the embodiments of the present disclosure.

As shown in FIG. 4, the electronic device 300 may include a processing apparatus (such as a central processing unit or a graphics processing unit) 301. The processing apparatus 301 may perform various proper actions and processing according to a program stored in a read-only memory (ROM) 302 or a program loaded into a random-access memory (RAM) 303 from a storage apparatus 308. Various programs and data required for operations of the electronic device 300 are also stored in the RAM 303. The processing apparatus 301, the ROM 302, and the RAM 303 are connected to each other via a bus 304. An input/output (I/O) interface 305 is also connected to the bus 304.

Generally, the following apparatuses may be connected to the I/O interface 305: an input apparatus 306 including, for example, a touchscreen, a touchpad, a keyboard, a mouse, a camera, a microphone, an accelerometer, and a gyroscope, an output apparatus 307 including, for example, a liquid crystal display (LCD), a speaker, and a vibrator, the storage apparatus 308 including, for example, a magnetic tape and a hard disk, and a communication apparatus 309. The communication apparatus 309 may allow the electronic device 300 to perform wireless or wired communication with other devices to exchange data. Although FIG. 4 shows the electronic device 300 having various apparatuses, it is to be understood that it is not required to implement or have all the shown apparatuses. Alternatively, more or fewer apparatuses may be implemented or present.

Particularly, according to the embodiments of the present disclosure, the process described above with reference to a flowchart may be implemented as a computer software program. For example, a computer program product is included in the embodiments of the present disclosure. The computer program product includes a computer program carried on a computer-readable medium. The computer program includes program codes for executing a method for detecting a click on an icon. In such embodiments, the computer program may be downloaded and installed from a network through the communication apparatus 309, installed from the storage apparatus 308, or installed from the ROM 302. When the computer program is executed by the processing apparatus 301, the preceding functions defined in the method in the embodiments of the present disclosure are implemented.

It is to be noted that the preceding computer-readable medium in the present disclosure may be a computer-readable signal medium or a computer-readable storage medium or any combination thereof. For example, the computer-readable storage medium may be, but is not limited to, an electrical, magnetic, optical, electromagnetic, infrared, or semiconductor system, apparatus, or device or any combination thereof. Concrete examples of the computer-readable storage medium may include, but are not limited to, an electrical connection having one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical memory device, a magnetic memory device, or any suitable combination thereof. In the present disclosure, the computer-readable storage medium may be any tangible medium including or storing a program. The program may be used by an instruction execution system, apparatus, or device or used in conjunction with an instruction execution system, apparatus, or device. In the present disclosure, the computer-readable signal medium may include a data signal propagated in a baseband or as a part of a carrier, and computer-readable program codes are carried in the data signal. The data signal propagated in this manner may be in multiple forms, including, but not limited to, an electromagnetic signal, an optical signal, or any suitable combination thereof. The computer-readable signal medium may also be any computer-readable medium except the computer-readable storage medium. The computer-readable signal medium may send, propagate, or transmit a program used by an instruction execution system, apparatus, or device or used in conjunction with an instruction execution system, apparatus, or device. The program codes included on the computer-readable medium may be transmitted by any suitable medium, including, but not limited to, a wire, an optical cable, a radio frequency (RF), or any suitable combination thereof.

In some embodiments, clients and servers may communicate by using any network protocol currently known or developed in the future, such as a Hypertext Transfer Protocol (HTTP), and may be interconnected to any form or medium of digital data communication (for example, a communication network). Examples of the communication network include a local area network (LAN), a wide area network (WAN), an inter-network (for example, the Internet), a peer-to-peer network (for example, an ad hoc network), and any network currently known or developed in the future.

The preceding computer-readable medium may be included in the preceding electronic device or may exist alone without being assembled into the electronic device.

The preceding computer-readable medium carries one or more programs, where the one or more programs, when executed by the electronic device, cause the electronic device to acquire an original image including a target icon; segment the original image into a foreground and a background to obtain a two-dimensional mask image, where a value of a pixel point in the two-dimensional mask image represents whether the pixel point corresponds to the target icon; acquire position information of a click operation on a control corresponding to the target icon; determine whether the position information and a value of a pixel point corresponding to the position information in the two-dimensional mask image satisfy a set condition; and if the position information and the value of the pixel point corresponding to the position information in the two-dimensional mask image satisfy the set condition, determine that the target icon is clicked and control the target icon to execute a service logic corresponding to the click operation.

Computer program codes for executing operations in the present disclosure may be written in one or more programming languages or a combination thereof The preceding programming languages include, but are not limited to, object-oriented programming languages such as Java, Smalltalk, and C++ and also include conventional procedural programming languages such as C or similar programming languages. Program codes may be executed entirely on a user computer, executed partly on a user computer, executed as a stand-alone software package, executed partly on a user computer and partly on a remote computer, or executed entirely on a remote computer or a server. In the case where the remote computer is involved, the remote computer may be connected to the user computer via any type of network including a local area network (LAN) or a wide area network (WAN) or may be connected to an external computer (for example, via the Internet through an Internet service provider).

Flowcharts and block diagrams among the drawings illustrate architectures, functions, and operations possible to implement in accordance with the system, method, and computer program product in various embodiments of the present disclosure. In this regard, each block in the flowcharts or block diagrams may represent a module, program segment, or part of codes, where the module, program segment, or part of codes includes one or more executable instructions for implementing specified logical functions. It is to be noted that in some alternative implementations, functions marked in blocks may occur in an order different from that marked in the drawings. For example, two successive blocks may, in fact, be executed substantially in parallel or in reverse order, which depends on the functions involved. It is also to be noted that each block in the block diagrams and/or flowcharts and a combination of blocks in the block diagrams and/or flowcharts may be implemented by a special-purpose hardware-based system executing a specified function or operation or may be implemented by a combination of special-purpose hardware and computer instructions.

The involved units described in the embodiments of the present disclosure may be implemented by software or hardware. The name of a unit is not intended to limit the unit itself in some circumstance.

The functions described above herein may be at least partially implemented by one or more hardware logic components. For example, without limitation, example types of hardware logic component that can be used include a field-programmable gate array (FPGA), an application-specific integrated circuit (ASIC), an application-specific standard product (ASSP), a system-on-chip (SoC), a complex programmable logic device (CPLD), and the like.

In the context of the present disclosure, a machine-readable medium may be a tangible medium that may include or store a program used by an instruction execution system, apparatus, or device or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device or any suitable combination thereof. Concrete examples of the machine-readable storage medium include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination thereof

According to one or more embodiments among embodiments of the present disclosure, the embodiments of the present disclosure disclose a method for detecting a click on an icon.

The method includes the steps described below.

An original image including a target icon is acquired.

The original image is segmented into a foreground and a background so that a two-dimensional mask image is obtained, where a value of a pixel point in the two-dimensional mask image represents whether the pixel point corresponds to the target icon.

Position information of a click operation on a control corresponding to the target icon is acquired.

It is determined whether the position information and a value of a pixel point corresponding to the position information in the two-dimensional mask image satisfy a set condition.

If the position information and the value of the pixel point corresponding to the position information in the two-dimensional mask image satisfy the set condition, it is determined that the target icon is clicked and the target icon is controlled to execute a service logic corresponding to the click operation.

Further, the step in which the original image is segmented into the foreground and the background so that the two-dimensional mask image is obtained includes the steps described below.

Gradation processing is performed on the original image so that a grayscale image is obtained.

The grayscale image is segmented into the foreground and the background so that the two-dimensional mask image is obtained.

Further, after the original image is segmented into the foreground and the background so that the two-dimensional mask image is obtained, the method further includes the step described below.

A bit array is created according to the two-dimensional mask image and dimension information of the original image.

The step of determining whether the position information and the value of the pixel point corresponding to the position information in the two-dimensional mask image satisfy the set condition includes the step described below.

It is determined whether a value of a position corresponding to the position information in the bit array is a first set value.

Further, the step in which the bit array is created according to the two-dimensional mask image and dimension information of the original image includes the steps described below.

An empty bit array with a corresponding size is created according to the dimension information of the original image.

Pixel points in the two-dimensional mask image are traversed; if a value of a pixel point satisfies a first condition, a value of a position corresponding to the pixel point in the empty bit array is set to be the first set value; and if a value of a pixel point satisfies a second condition, a value of a position corresponding to the pixel point in the empty bit array is set to be a second set value; where the first condition is that the pixel point is the foreground, and the second condition is that the pixel point is the background.

Further, after the bit array is created according to the two-dimensional mask image and the dimension information of the original image, the method further includes the step described below.

The original image and the dimension information are selected from a memory.

Further, the step in which position information of the click operation in a region where the target icon is located is acquired includes the steps described below.

Position information of the click operation in an interface window is acquired.

A transformation matrix between the interface window and the control where the target icon is located is acquired.

The position information is transformed according to the transformation matrix so that the position information of the click operation on the control where the target icon is located is obtained.

Further, the step in which the position information is transformed according to the transformation matrix so that the position information of the click operation on the control where the target icon is located is obtained includes the step described below.

A dot product of the position information and an inverse matrix of the transformation matrix is calculated so that the position information of the click operation on the control where the target icon is located is obtained.

It is to be noted that the above are preferred embodiments of the present disclosure and the technical principles used therein. It is to be understood by those skilled in the art that the present disclosure is not limited to the embodiments described herein. Those skilled in the art can make various apparent modifications, adaptations, and substitutions without departing from the scope of the present disclosure. Therefore, while the present disclosure has been described in detail through the preceding embodiments, the present disclosure is not limited to the preceding embodiments and may include other equivalent embodiments without departing from the concept of the present disclosure. The scope of the present disclosure is determined by the scope of the appended claims.

What is claimed is:

1. A method for detecting a click on an icon, comprising:
acquiring an original image comprising a target icon;
segmenting the original image into a foreground and a background to obtain a two-dimensional mask image, wherein a value of a pixel point in the two-dimensional mask image represents whether the pixel point corresponds to the target icon;
acquiring position information of a click operation on a control corresponding to the target icon;
determining whether the position information and a value of a pixel point corresponding to the position information in the two-dimensional mask image satisfy a set condition; and
in response to determining that the position information and the value of the pixel point corresponding to the position information in the two-dimensional mask image satisfy the set condition, determining that the target icon is clicked and controlling the target icon to execute a service logic corresponding to the click operation.

2. The method of claim 1, wherein segmenting the original image into the foreground and the background to obtain the two-dimensional mask image comprises:
performing gradation processing on the original image to obtain a grayscale image; and
segmenting the grayscale image into the foreground and the background to obtain the two-dimensional mask image.

3. The method of claim 1, after segmenting the original image into the foreground and the background to obtain the two-dimensional mask image, further comprising:
creating a bit array according to the two-dimensional mask image and dimension information of the original image; and
wherein determining whether the position information and the value of the pixel point corresponding to the position information in the two-dimensional mask image satisfy the set condition comprises:
determining whether a value of a position corresponding to the position information in the bit array is a first set value.

4. The method of claim 3, wherein creating the bit array according to the two-dimensional mask image and the dimension information of the original image comprises:
creating an empty bit array with a corresponding size according to the dimension information of the original image; and
traversing pixel points in the two-dimensional mask image; in a case where a value of a traversed pixel point satisfies a first condition, setting a value of a position corresponding to the pixel point in the empty bit array to be the first set value; and in a case where a value of a traversed pixel point satisfies a second condition, setting a value of a position corresponding to the pixel point in the empty bit array to be a second set value; wherein the first condition is that the pixel point is the foreground, and the second condition is that the pixel point is the background.

5. The method of claim 3, after creating the bit array according to the two-dimensional mask image and the dimension information of the original image, further comprising:
deleting the original image and the dimension information from a memory.

6. The method of claim 1, wherein acquiring the position information of the click operation on the control corresponding to the target icon comprises:
acquiring position information of the click operation in an interface window;
acquiring a transformation matrix between the interface window and the control where the target icon is located; and
transforming the position information according to the transformation matrix to obtain the position information of the click operation on the control where the target icon is located.

7. The method of claim 6, wherein transforming the position information according to the transformation matrix to obtain the position information of the click operation on the control where the target icon is located comprises:
calculating a dot product of the position information and an inverse matrix of the transformation matrix to obtain the position information of the click operation on the control where the target icon is located.

8. An electronic device, comprising:
at least one processing apparatus; and
a storage apparatus configured to store at least one program;
wherein the at least one program, when executed by the at least one processing apparatus, causes the at least one processing apparatus to perform:
acquiring an original image comprising a target icon;
segmenting the original image into a foreground and a background to obtain a two-dimensional mask image, wherein a value of a pixel point in the two-dimensional mask image represents whether the pixel point corresponds to the target icon;
acquiring position information of a click operation on a control corresponding to the target icon;
determining whether the position information and a value of a pixel point corresponding to the position information in the two-dimensional mask image satisfy a set condition; and
in response to determining that the position information and the value of the pixel point corresponding to the position information in the two-dimensional mask image satisfy the set condition, determining that the target icon is clicked and controlling the target icon to execute a service logic corresponding to the click operation.

9. The electronic device of claim 8, wherein the at least one program, when executed by the at least one processing apparatus, causes the at least one processing apparatus to perform segmenting the original image into the foreground and the background to obtain the two-dimensional mask image in the following way:
performing gradation processing on the original image to obtain a grayscale image; and
segmenting the grayscale image into the foreground and the background to obtain the two-dimensional mask image.

10. The electronic device of claim 8, wherein the at least one program, when executed by the at least one processing apparatus, causes the at least one processing apparatus to, after segmenting the original image into the foreground and the background to obtain the two-dimensional mask image, further perform:
creating a bit array according to the two-dimensional mask image and dimension information of the original image; and
wherein the at least one program, when executed by the at least one processing apparatus, causes the at least one processing apparatus to perform determining whether the position information and the value of the pixel point corresponding to the position information in the two-dimensional mask image satisfy the set condition in the following way:
determining whether a value of a position corresponding to the position information in the bit array is a first set value.

11. The electronic device of claim 10, wherein the at least one program, when executed by the at least one processing apparatus, causes the at least one processing apparatus to perform creating the bit array according to the two-dimensional mask image and the dimension information of the original image in the following way:
creating an empty bit array with a corresponding size according to the dimension information of the original image; and
traversing pixel points in the two-dimensional mask image; in a case where a value of a traversed pixel point satisfies a first condition, setting a value of a position corresponding to the pixel point in the empty bit array to be the first set value; and in a case where a value of a traversed pixel point satisfies a second condition, setting a value of a position corresponding to the pixel point in the empty bit array to be a second set value; wherein the first condition is that the pixel point is the foreground, and the second condition is that the pixel point is the background.

12. The electronic device of claim 10, wherein the at least one program, when executed by the at least one processing apparatus, causes the at least one processing apparatus to, after creating the bit array according to the two-dimensional mask image and the dimension information of the original image, further perform:
deleting the original image and the dimension information from a memory.

13. The electronic device of claim 8, wherein the at least one program, when executed by the at least one processing apparatus, causes the at least one processing apparatus to perform acquiring the position information of the click operation on the control corresponding to the target icon in the following way:
acquiring position information of the click operation in an interface window;
acquiring a transformation matrix between the interface window and the control where the target icon is located; and
transforming the position information according to the transformation matrix to obtain the position information of the click operation on the control where the target icon is located.

14. The electronic device of claim 13, wherein the at least one program, when executed by the at least one processing apparatus, causes the at least one processing apparatus to perform transforming the position information according to the transformation matrix to obtain the position information of the click operation on the control where the target icon is located in the following way:
calculating a dot product of the position information and an inverse matrix of the transformation matrix to obtain the position information of the click operation on the control where the target icon is located.

15. A non-transitory computer-readable medium storing a computer program, wherein the computer program, when executed by a processing apparatus, causes the processing apparatus to perform:
acquiring an original image comprising a target icon;
segmenting the original image into a foreground and a background to obtain a two-dimensional mask image, wherein a value of a pixel point in the two-dimensional mask image represents whether the pixel point corresponds to the target icon;
acquiring position information of a click operation on a control corresponding to the target icon;
determining whether the position information and a value of a pixel point corresponding to the position information in the two-dimensional mask image satisfy a set condition; and
in response to determining that the position information and the value of the pixel point corresponding to the position information in the two-dimensional mask image satisfy the set condition, determining that the target icon is clicked and controlling the target icon to execute a service logic corresponding to the click operation.

16. The non-transitory computer-readable medium of claim 15, wherein the computer program, when executed by a processing apparatus, causes the processing apparatus to perform segmenting the original image into the foreground and the background to obtain the two-dimensional mask image in the following way:
performing gradation processing on the original image to obtain a grayscale image; and
segmenting the grayscale image into the foreground and the background to obtain the two-dimensional mask image.

17. The non-transitory computer-readable medium of claim 15, wherein the computer program, when executed by a processing apparatus, causes the processing apparatus to, after segmenting the original image into the foreground and the background to obtain the two-dimensional mask image, further perform:
creating a bit array according to the two-dimensional mask image and dimension information of the original image; and
wherein the computer program, when executed by a processing apparatus, causes the processing apparatus to perform determining whether the position information and the value of the pixel point corresponding to the position information in the two-dimensional mask image satisfy the set condition in the following way:
determining whether a value of a position corresponding to the position information in the bit array is a first set value.

18. The non-transitory computer-readable medium of claim 17, wherein the computer program, when executed by a processing apparatus, causes the processing apparatus to perform creating the bit array according to the two-dimensional mask image and the dimension information of the original image in the following way:
creating an empty bit array with a corresponding size according to the dimension information of the original image; and
traversing pixel points in the two-dimensional mask image; in a case where a value of a traversed pixel point satisfies a first condition, setting a value of a position corresponding to the pixel point in the empty bit array to be the first set value; and in a case where a value of a traversed pixel point satisfies a second condition, setting a value of a position corresponding to the pixel point in the empty bit array to be a second set value; wherein the first condition is that the pixel point is the foreground, and the second condition is that the pixel point is the background.

19. The non-transitory computer-readable medium of claim 17, wherein the computer program, when executed by a processing apparatus, causes the processing apparatus to, after creating the bit array according to the two-dimensional mask image and the dimension information of the original image, further perform:
deleting the original image and the dimension information from a memory.

20. The non-transitory computer-readable medium of claim 15, wherein the computer program, when executed by a processing apparatus, causes the processing apparatus to perform acquiring the position information of the click operation on the control corresponding to the target icon in the following way:
acquiring position information of the click operation in an interface window;
acquiring a transformation matrix between the interface window and the control where the target icon is located; and
transforming the position information according to the transformation matrix to obtain the position information of the click operation on the control where the target icon is located.
